(19) United States
(12) Patent Application Publication
(10) Pub. No.: US 2014/0024410 A1
(43) Pub. Date: Jan. 23, 2014

(54) MOBILE DEVICE WITH SELECTIVE WLAN RECEIVE GAIN LEVELS AND RELATED METHODS

(71) Applicants: Fei HE, Waterloo (CA); Jun Xu, Scarborough (CA); Lizhong Zhu, Waterloo (CA)

(72) Inventors: Fei HE, Waterloo (CA); Jun Xu, Scarborough (CA); Lizhong Zhu, Waterloo (CA)

(73) Assignee: Research In Motion Limited, Waterloo (CA)

(21) Appl. No.: 13/552,753

(22) Filed: Jul. 19, 2012

(51) Int. Cl. H04W 88/06; H04W 52/52

(52) U.S. Cl. 455/552.1

(57) ABSTRACT

A mobile wireless communications device may include a housing, a cellular transceiver carried by the housing and to operate at a given transmit power level from among different transmit power levels, and a WLAN transceiver carried by the housing and to operate at a given receive gain level from among different receive gain levels. The mobile wireless communications device may also include a controller to select the given receive gain level based upon the given transmit power level of the cellular transceiver.

### RELATED METHODS

1. Technical Field

The present invention relates to the field of communications, and, more particularly, to wireless communications and related methods.

2. Background

Cellular communication systems continue to grow in popularity and have become an integral part of both personal and business communications. Cellular telephones allow users to place and receive phone calls almost anywhere they travel. Moreover, as cellular telephone technology is advanced, so too has the functionality of cellular devices. For example, many cellular devices now incorporate Personal Digital Assistant (PDA) features such as calendars, address books, task lists, calculators, memo and writing programs, etc. These multi-function devices usually allow users to wirelessly send and receive electronic mail (email) messages and access the internet via a cellular network and/or a wireless local area network (WLAN), for example.

Cellular devices have radio frequency (RF) processing circuits and receive or transmit radio communications signals typically using modulation schemes. The typical cellular device may have multiple transmit and receive pathways from the antenna to a digital signal processor (DSP). In particular, each signal pathway may comprise a filter to help isolate the desired frequency band from extraneous electromagnetic signals, for example, noise and interference.

Nevertheless, as frequency bands change because of regulatory reasons, expansion, etc. and as more transceivers are added to the cellular device, the likelihood of self-interference may increase. For example, the cellular transceiver may desensitize the wireless local area network (WLAN) transceiver during transmission periods, i.e. potentially rendering the WLAN transceiver inoperative.

### BRIEF DESCRIPTION OF THE DRAWINGS

FIG. 1 is a schematic block diagram of an example embodiment of a mobile wireless communications device.

FIG. 2 is a detailed schematic block diagram of an example embodiment of the WLAN transceiver from the mobile wireless communications device of FIG. 1.

FIG. 3 is a flowchart illustrating operation of an example embodiment of the mobile wireless communications device of FIG. 1.

FIGS. 4-8 are charts illustrating performance of an example embodiment of a mobile wireless communications device.

FIG. 9 is a schematic block diagram illustrating example components of a mobile wireless communications device that may be used with the mobile wireless communications device of FIG. 1.

### DETAILED DESCRIPTION

The present description is made with reference to the accompanying drawings, in which embodiments are shown. However, many different embodiments may be used, and thus the description should not be construed as limited to the embodiments set forth herein. Rather, these embodiments are provided so that this disclosure will be thorough and complete. Like numbers refer to like elements throughout.

Generally speaking, a mobile wireless communications device may include a housing, a cellular transceiver carried by the housing and configured to operate at a given transmit power level from among a plurality different transmit power levels, and a WLAN transceiver carried by the housing and configured to operate at a given receive gain level from among a plurality of different receive gain levels. The mobile wireless communications device may also include a controller configured to select the given receive gain level based upon the given transmit power level of the cellular transceiver.

More specifically, the controller may be configured to select the given receive gain level to be a lower receive gain level based upon the given transmit power level being a higher transmit power level. Also, the controller may be configured to select the given receive gain level to be a higher receive gain level based upon the given transmit power level being a lower transmit power level.

In some embodiments, the controller may be configured to dynamically select the given transmit power level, and dynamically select the given receive gain level. The controller may further comprise a memory configured to store a table of the plurality different transmit power levels and the corresponding plurality of different receive gain levels.

The mobile wireless communications device may further comprise a WLAN antenna coupled to the WLAN transceiver, and the WLAN transceiver may comprise an amplifier coupled downstream from the WLAN antenna. Additionally, the WLAN transceiver may be configured to operate the amplifier based upon the given receive gain level. The WLAN transceiver may comprise at least one mixer downstream from the amplifier, at least one filter downstream from the at least one mixer, and an analog-to-digital converter downstream from the at least one filter. For example, the WLAN transceiver may comprise an IEEE 802.11 transceiver, and the cellular transceiver may comprise at least one of a long term evolution (LTE) transceiver and a WiMAX IEEE 802.16 transceiver.

Another aspect is directed to a method of operating a mobile wireless communications device comprising a cellular transceiver operating at a given transmit power level from among a plurality different transmit power levels, and a WLAN transceiver operating at a given receive gain level from among a plurality of different receive gain levels. The method may include selecting the given receive gain level based upon the given transmit power level of the cellular transceiver.

Example mobile wireless communications devices may include portable or personal media players (e.g., music or MP3 players, video players, etc.), remote controls (e.g., television or stereo remotes, etc.), portable gaming devices, portable or mobile telephones, smartphones, tablet computers, etc.

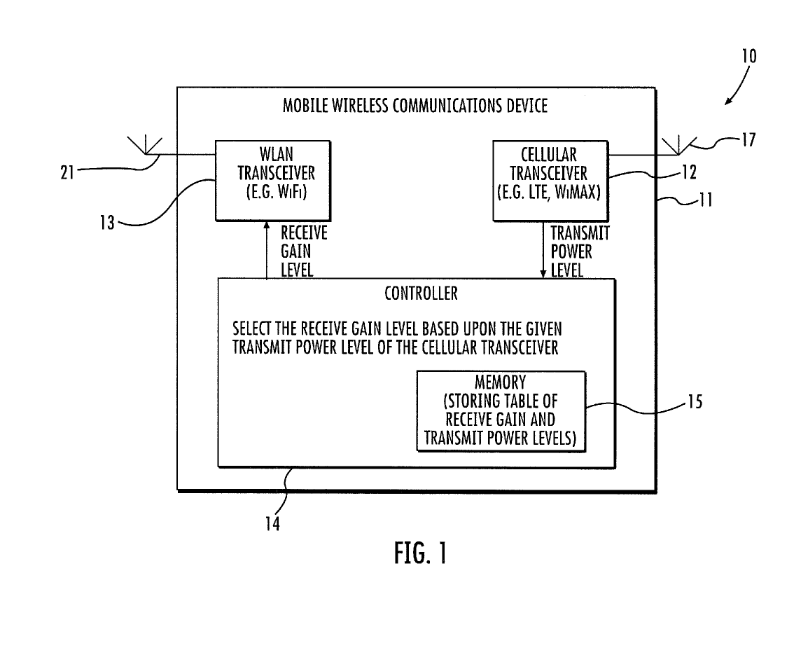

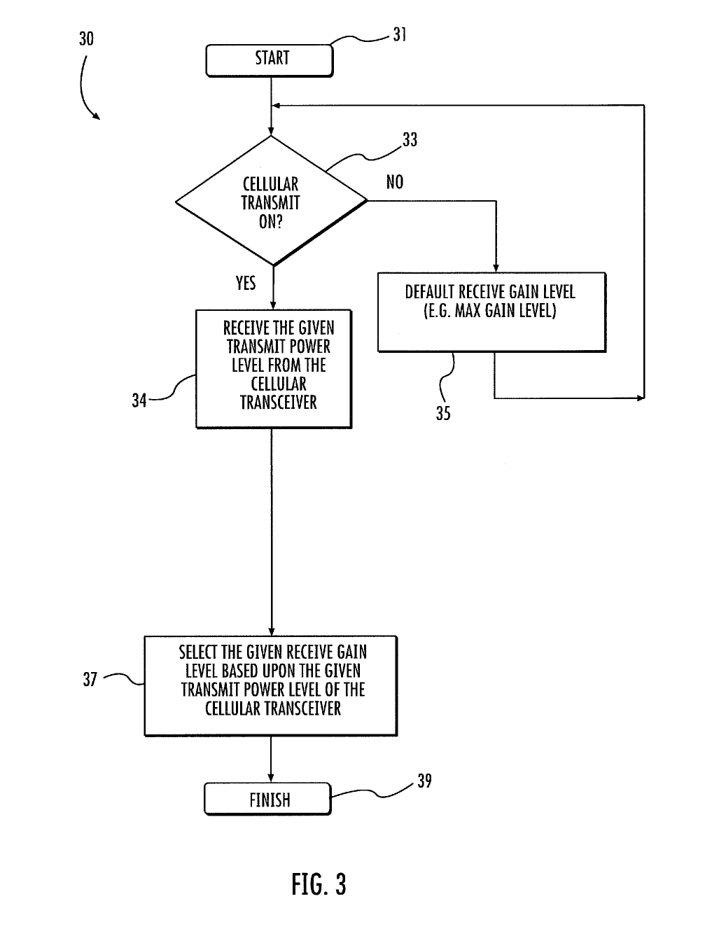

Referring now to FIG. 1, a mobile wireless communications device 10 according to the present disclosure is now described. Moreover, with reference additionally to FIG. 3, a flowchart 30 illustrates a method of operating the mobile wireless communications device 10 (Block 31). The mobile wireless communications device 10 illustratively includes a housing 11, and a cellular transceiver 12 carried by the housing and configured to operate at a given transmit power level from among a plurality different transmit power levels. The given transmit power level of the cellular transceiver 12 may be based upon a given cellular standard and directions from the base station.

The mobile wireless communications device 10 illustratively includes a WLAN transceiver 13 carried by the housing 11 and configured to operate at a given receive gain level from among a plurality of different receive gain levels. For example, the WLAN transceiver 13 may comprise an IEEE 802.11 transceiver, and the cellular transceiver 12 may comprise one or more of an LTE transceiver and a WiMAX IEEE 802.16 transceiver. In the illustrated embodiment, the mobile wireless communications device 10 includes a cellular antenna 17 coupled to the cellular transceiver 12, and a WLAN antenna 21 coupled to the WLAN transceiver 13.

The mobile wireless communications device 10 illustratively includes a controller 14 configured to select the given receive gain level based upon the given transmit power level of the cellular transceiver. If the cellular transceiver 12 is not transmitting, the controller 14 makes no changes to regular receive gain levels in the WLAN transceiver 13 (Blocks 33, 35), i.e. purely attempting to maximize WLAN receive signal dynamic range and signal quality. On the other hand, during cellular transmit operations, the controller 14 will adjust receive gain levels to reduce the WLAN desensitization effect from the cellular transceiver 12 (Blocks 34, 37, 39), i.e. backing off WLAN receive gain levels to attempt to prevent desensitization.

In some embodiments, the controller 14 may be configured to select the given receive gain level to be a lower receive gain level based upon the given transmit power level being a higher transmit power level. In short, the sensitivity of the WLAN transceiver 13 is improved by decreasing the receive gain level thereof. Also, the controller 14 may be configured to select the given receive gain level to be a higher receive gain level based upon the given transmit power level being a lower transmit power level. In advantageous embodiments, the controller 14 may be configured to dynamically select the given transmit power level, and dynamically select the given receive gain level. In the illustrated embodiment, the controller 14 comprises a memory 15 configured to store a table of the plurality different transmit power levels and the corresponding plurality of different receive gain levels. This may cause the controller 14 to better tailor the WLAN receive gain level to the power of the cellular transmission causing the desensitization.

Although in the illustrated embodiment, the disclosed method is used to mitigate interference from the cellular transceiver 12 in the mobile wireless communications device 10, the method may be applied to self-interference from other transmitters. In other words, the cellular transceiver 12 and the WLAN transceiver 13 may each comprise another type of transceiver.

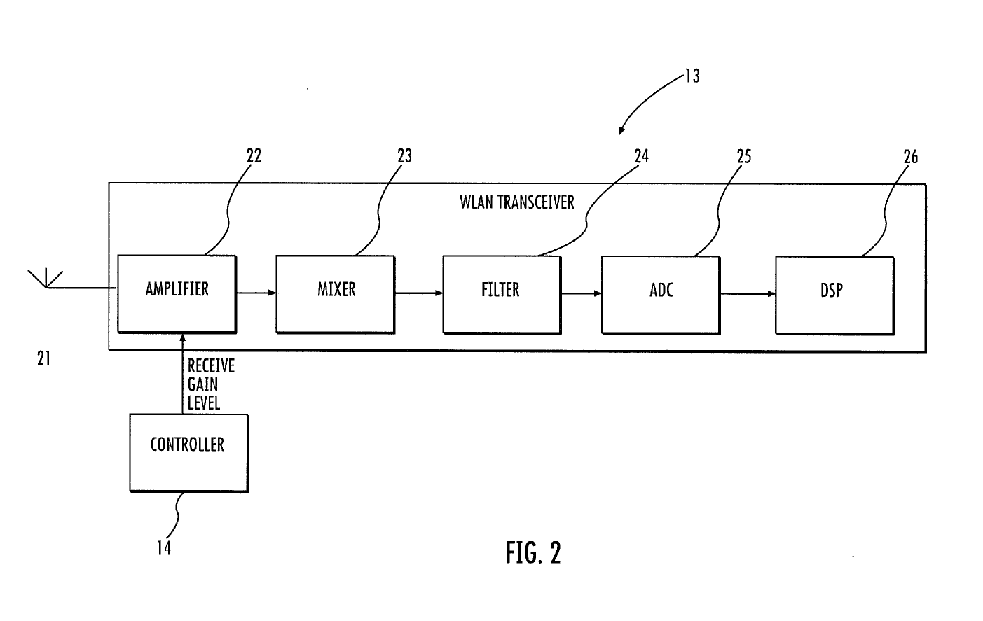

Referring now additionally to FIG. 2, the receiver chain of the WLAN transceiver 13 is shown in detail. The WLAN transceiver comprises an amplifier 22 coupled downstream from the WLAN antenna, a mixer 23 downstream from the amplifier, a filter 24 downstream from the mixer, an analog-to-digital converter (ADC) 25 downstream from the at least one filter, and a digital signal processor 26 downstream from the ADC. Additionally, the WLAN transceiver 13 may be configured to operate the amplifier 22 based upon the given receive gain level.

Another aspect is directed to a method of operating a mobile wireless communications device 10 comprising a cellular transceiver 12 operating at a given transmit power level from among a plurality different transmit power levels, and a WLAN transceiver 13 operating at a given receive gain level from among a plurality of different receive gain levels. The method may include selecting the given receive gain level based upon the given transmit power level of the cellular transceiver 12.

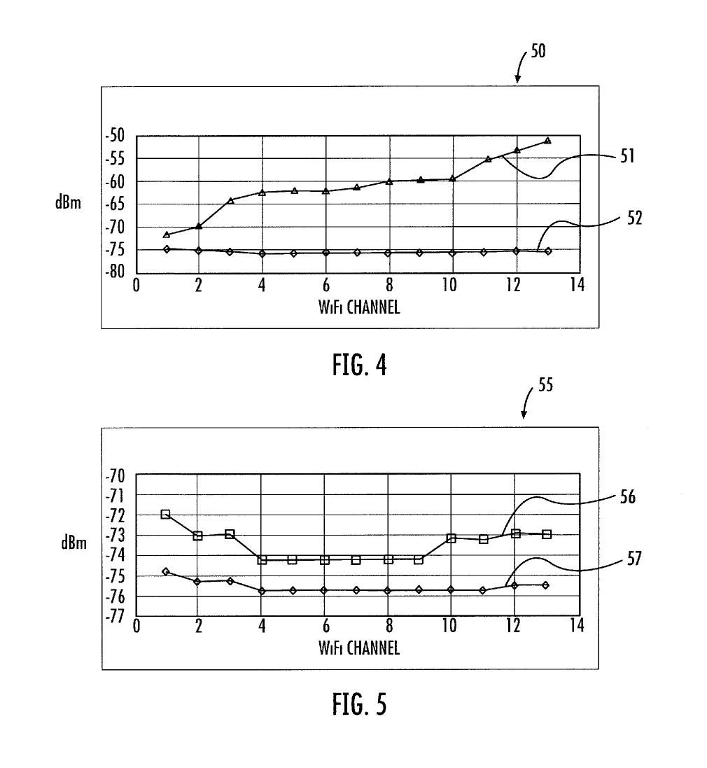

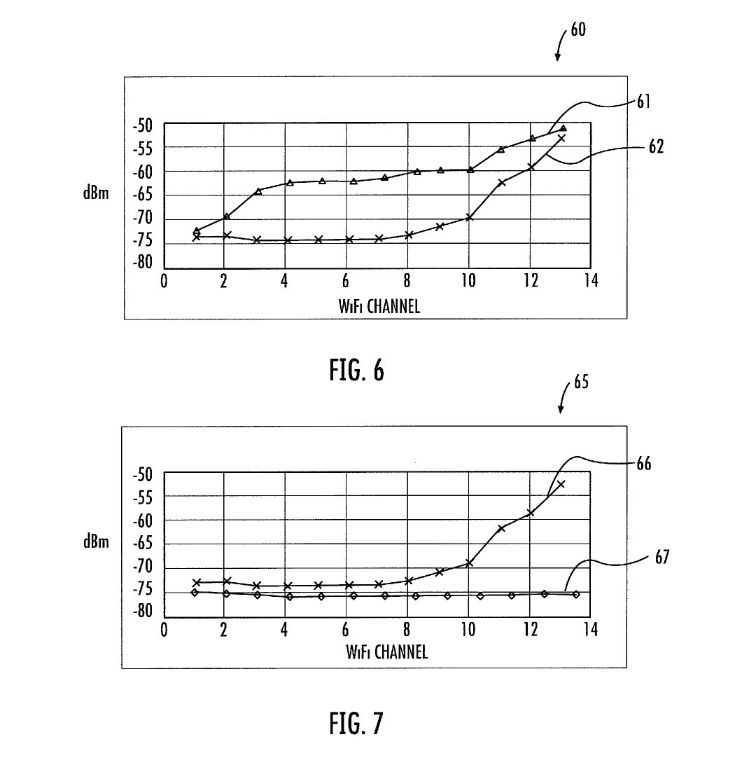

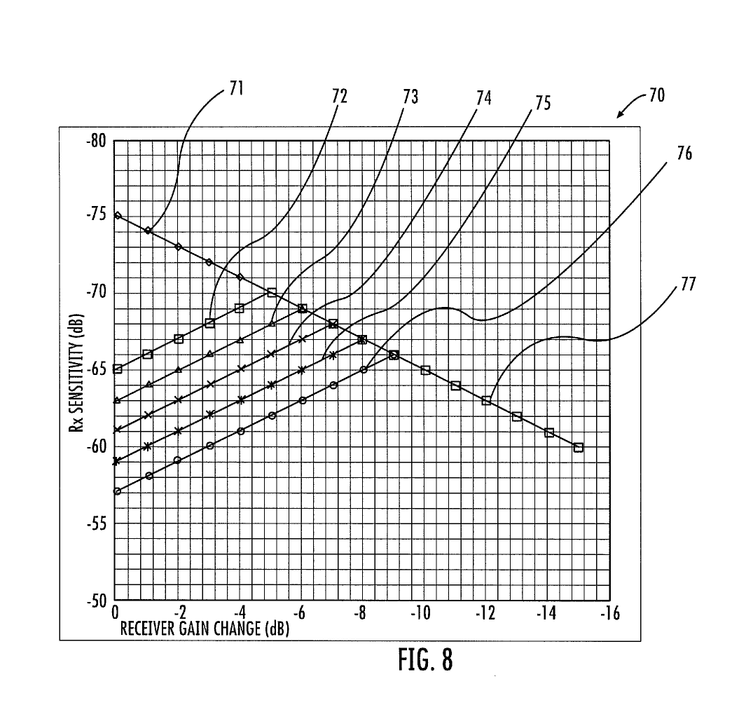

Referring now to FIGS. 4-8, a simulation of performance of an example embodiment of the mobile wireless communications device 10 is now described. It has been observed that in some example implementations, there may be an issue with radiated radio performance. Partially, that is because of self de-sensitization due to limited antenna isolation on a handheld wireless device, such as when the WLAN 802.11b/g receiver (2402-2483 MHz) is de-sensed by the LTE transmitter B7 (2500-2570 MHz). Typically, automatic gain control (AGC) control algorithms are targeted for best receiver sensitivity and dynamic range for in-band signal.

To provide an approach to the issue described above, the herein described method may provide best out-of-band blocking performance of a radio receiver without damaging the receiver in-band sensitivity during the absence of the out-of-band interference. For example, when strong out-of-band interference is detected, the controller 14 may adaptively adjust the receiver chain based on the strength of the out-of-band interfering signal with minimal impact to in-band receiver sensitivity.

For example, a diagram 50 shows WLAN receiver sensitivity data across the frequency band, from Channel (CH) 1 to CH13. Curve 52 shows sensitivity without any blocking signal, and curve 51 shows sensitivity with 20M LTE UL transmitting at 2510 MHz. As will be appreciated, the receiver is jammed while LTE radio is transmitting, the sensitivity degraded by about 3 to 23 dBm from CH1 to CH13.

In order to improve the blocking performance of the WLAN receiver, the method disclosed herein intentionally sacrifices the in-band signal sensitivity as shown in diagram 55. Curves 56 shows the sensitivity without any blocking signal and with the gain table changes while curve 57 shows the sensitivity without any blocking signal and without the gain table changes. The receiver sensitivity with gain table change is about 2-3 dBm worse than that of original gain setting across the frequency band.

Now, in diagram 60, the sensitivity with (curve 62) and without (curve 61) gain table changes is compared, while the LTE blocking signal is present. As will be appreciated, there is an improvement due to the gain table change in comparison with the presence of the out-of-band blocking signal. It should be noted that since this gain table may be permanent, the receiver sensitivity will be degraded by about 3 dBm even without the preset of the out-of-band blocking signal as illustrated also in diagram 60 for those lower channels.

Therefore, to provide an approach to this issue, an adaptive algorithm of the gain table control is disclosed. By detecting the presence of the out-of-band blocking signal, the controller 14 may maintain the best receiver sensitivity and blocking performance no matter the out-of-band blocking signal is there or not.

To understand the method, diagram 65 provides two curves of WLAN sensitivity data across the 2.4 GHz ISM band with 13 channels. Curve 67 is the sensitivity without the gain change and in the absence of the out-of-band blocking signal (which, for example, is the 1st TX channel of LTE Band 7). Curve 66 is the sensitivity with gain table change and in the presence of the blocking signal. When the blocking signal appears, which the controller 14 has pre-knowledge of from the controller of the LTE transceiver, the controller may change the gain table to get better blocking performance, overall sensitivity and data throughput. When the blocking signal is gone, the controller 14 may switch the gain table back to nominal value to achieve the best sensitivity.

Furthermore, during the presence of the out-of-band blocking signal, the blocking signal strength could vary significantly. To achieve the best trade-off of the in-band receiver sensitivity and out-of-band blocking performance, the receiver gain table vs. the blocking signal strength should be properly established. Then, the proper gain table for each blocking signal level could be set, respectively, and the optimal blocking performance for each channel could be achieved.

In diagram 70, the relationship between the WLAN receiver 13 sensitivity and different blocking signal levels is shown. With a different blocking signal level, there is a different gain change point to achieve the best sensitivity during the presence of the blocking signal.

For example, with the blocking signal strength being at level 5 (curve 76) it is found that the best blocking performance of −66 dBm sensitivity is achieved by backing off the receiver gain by about 9 dBm. However, with weaker blocking signal strength at level 1 (Curve 72), a best blocking performance of −70 dBm sensitivity is achieved by backing off the receiver gain by about 5 dBm. If the controller 14 does not change the gain setting and maintains the original back-off gain setting of 9 dBm, the WLAN receiver 13 sensitivity would stay at 66 dBm. Curve 71 shows RX sensitivity without the blocking signal. Curves 72-76 show corresponding RX sensitivity with the blocking signal at power levels 1-5, respectively.

Therefore, based on the analysis of this relationship between the blocking signal level and the receiver gain back-off and the benefit of achieving the optimal receiver sensitivity during the presence of the out-of-band blocking signal, the controller 14 shall adaptively change the gain setting of receiver chain with respect to level of blocking signal strength, to achieve the best overall sensitivity and data throughput in different environments.

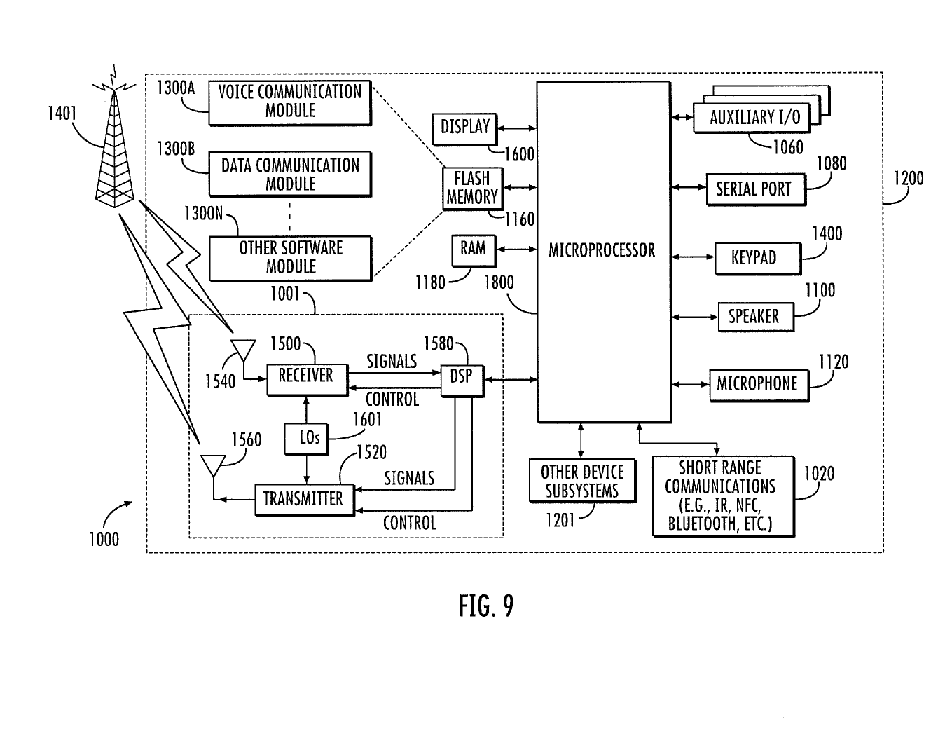

Example components of a mobile wireless communications device 1000 that may be used in accordance with the above-described embodiments are further described below with reference to FIG. 9. The device 1000 illustratively includes a housing 1200, a keyboard or keypad 1400 and an output device 1600. The output device shown is a display 1600, which may comprise a full graphic liquid crystal display (LCD). Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400.

The housing 1200 may be elongated vertically, or may take on other sizes and shapes (including clamshell housing structures). The keypad may include a mode selection key, or other hardware or software for switching between text entry and telephony entry.

In addition to the processing device 1800, other parts of the mobile device 1000 are shown schematically in FIG. 9. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The mobile device 1000 may comprise a two-way RF communications device having data and, optionally, voice communications capabilities. In addition, the mobile device 1000 may have the capability to communicate with other computer systems via the Internet.

Operating system software executed by the processing device 1800 is stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM may be capable of organizing and managing data items, such as e-mail, calendar events, voice mails, appointments, and task items. The PIM application may also be capable of sending and receiving data items via a wireless network 1401. The PIM data items may be seamlessly integrated, synchronized and updated via the wireless network 1401 with corresponding data items stored or associated with a host computer system.

Communication functions, including data and voice communications, are performed through the communications subsystem 1001, and possibly through the short-range communications subsystem 1020. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as Advanced Mobile Phone System (AMPS), time division multiple access (TDMA), code division multiple access (CDMA), Wideband code division multiple access (W-CDMA), personal communications service (PCS), GSM (Global System for Mobile Communications), enhanced data rates for GSM evolution (EDGE), etc. Other types of data and voice networks, both separate and integrated, may also be utilized with the mobile device 1000. The mobile device 1000 may also be compliant with other communications standards such as 3GSM, 3rd Generation Partnership Project (3GPP), Universal Mobile Telecommunications System (UMTS), 4G, etc.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore typically involves use of a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device may also be used to compose data items, such as e-mail messages, using the keypad 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, a Bluetooth™ communications module to provide for communication with similarly-enabled systems and devices, or a NFC sensor for communicating with a NFC device or NFC tag via NFC communications.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

1. A mobile wireless communications device comprising:
a housing;
a cellular transceiver carried by said housing and configured to operate at a given transmit power level from among a plurality different transmit power levels;
a wireless local area network (WLAN) transceiver carried by said housing and configured to operate at a given receive gain level from among a plurality of different receive gain levels; and
a controller configured to select the given receive gain level based upon the given transmit power level of said cellular transceiver.

2. The mobile wireless communications device of claim 1 wherein said controller is configured to select the given receive gain level to be a lower receive gain level based upon the given transmit power level being a higher transmit power level.

3. The mobile wireless communications device of claim 1 wherein said controller is configured to select the given receive gain level to be a higher receive gain level based upon the given transmit power level being a lower transmit power level.

4. The mobile wireless communications device of claim 1 wherein said controller is configured to dynamically select the given transmit power level, and dynamically select the given receive gain level.

5. The mobile wireless communications device of claim 1 wherein said controller further comprises a memory configured to store a table of the plurality different transmit power levels and the corresponding plurality of different receive gain levels.

6. The mobile wireless communications device of claim 1 further comprising a WLAN antenna coupled to said WLAN transceiver; and wherein said WLAN transceiver comprises an amplifier coupled downstream from said WLAN antenna.

7. The mobile wireless communications device of claim 6 wherein said WLAN transceiver is configured to operate said amplifier based upon the given receive gain level.

8. The mobile wireless communications device of claim 6 wherein said WLAN transceiver comprises at least one mixer downstream from said amplifier, at least one filter downstream from said at least one mixer, and an analog-to-digital converter downstream from said at least one filter.

9. The mobile wireless communications device of claim 1 wherein said WLAN transceiver comprises an IEEE 802.11 transceiver; and wherein said cellular transceiver comprises at least one of a long term evolution (LTE) transceiver and a WiMAX IEEE 802.16 transceiver.

10. A mobile wireless communications device comprising:
a housing;
a first transceiver carried by said housing and configured to operate at a given transmit power level from among a plurality different transmit power levels;
a second transceiver carried by said housing and configured to operate at a given receive gain level from among a plurality of different receive gain levels; and
a controller configured to select the given receive gain level based upon the given transmit power level of said first transceiver.

11. The mobile wireless communications device of claim 10 wherein said controller is configured to select the given receive gain level to be a lower receive gain level based upon the given transmit power level being a higher transmit power level.

12. The mobile wireless communications device of claim 10 wherein said controller is configured to select the given receive gain level to be a higher receive gain level based upon the given transmit power level being a lower transmit power level.

13. The mobile wireless communications device of claim 10 wherein said controller is configured to dynamically select the given transmit power level, and dynamically select the given receive gain level.

14. A mobile wireless communications device comprising:
a housing;
a long term evolution (LTE) transceiver carried by said housing and configured to operate at a given transmit power level from among a plurality different transmit power levels;
a wireless local area network (WLAN) transceiver carried by said housing and configured to operate at a given receive gain level from among a plurality of different receive gain levels; and
a controller configured to
select the given receive gain level to be a lower receive gain level based upon the given transmit power level being a higher transmit power level, and
select the given receive gain level to be a higher receive gain level based upon the given transmit power level being a lower transmit power level.

15. The mobile wireless communications device of claim 14 wherein said controller is configured to dynamically select the given transmit power level, and dynamically select the given receive gain level.

16. The mobile wireless communications device of claim 14 wherein said controller further comprises a memory configured to store a table of the plurality different transmit power levels and the corresponding plurality of different receive gain levels.

17. The mobile wireless communications device of claim 14 further comprising a WLAN antenna coupled to said WLAN transceiver; and wherein said WLAN transceiver comprises an amplifier coupled downstream from said WLAN antenna.

18. The mobile wireless communications device of claim 17 wherein said WLAN transceiver is configured to operate said amplifier based upon the given receive gain level.

19. The mobile wireless communications device of claim 17 wherein said WLAN transceiver comprises at least one mixer downstream from said amplifier, at least one filter downstream from said at least one mixer, and an analog-to-digital converter downstream from said at least one filter.

20. A method of operating a mobile wireless communications device comprising a cellular transceiver operating at a given transmit power level from among a plurality different transmit power levels, and a wireless local area network (WLAN) transceiver operating at a given receive gain level from among a plurality of different receive gain levels, the method comprising:
selecting the given receive gain level based upon the given transmit power level of the cellular transceiver.

21. The method of claim 20 further comprising selecting the given receive gain level to be a lower receive gain level based upon the given transmit power level being a higher transmit power level.

22. The method of claim 20 further comprising selecting the given receive gain level to be a higher receive gain level based upon the given transmit power level being a lower transmit power level.

23. The method of claim 20 further comprising dynamically selecting the given transmit power level, and dynamically selecting the given receive gain level.

24. The method of claim 20 further comprising storing a table of the plurality different transmit power levels and the corresponding plurality of different receive gain levels in a memory of the mobile wireless communications device.

25. The method of claim 20 further comprising a WLAN antenna coupled to the WLAN transceiver; and wherein the WLAN transceiver comprises an amplifier coupled downstream from the WLAN antenna.

26. The method of claim 20 wherein the WLAN transceiver comprises an IEEE 802.11 transceiver; and wherein the cellular transceiver comprises at least one of a long term evolution (LTE) transceiver and a WiMAX IEEE 802.16 transceiver.
